(19) United States
(12) Patent Application Publication
(10) Pub. No.: US 2007/0154228 A1
(43) Pub. Date: Jul. 5, 2007

(54) Universal smart chip cartridge for multiple printing apparatus

(75) Inventor: Alan K. Chan, Fairport, NY (US)

Correspondence Address: Timothy E. Nauman, Esq.;Fay, Sharpe, Fagan, Minnich & McKee, LLP, Seventh Floor, 1100 Superior Avenue, Cleveland, OH, 44114-2579, US

(73) Assignee: Nu-kote International, Inc.

(21) Appl. No.: 11/323,740

(22) Filed: Dec. 30, 2005

(51) Int. Cl. G03G 15/00

(52) U.S. Cl. 399/12

(57) ABSTRACT

A marking material cartridge for use with associated marking devices is provided. A universal electronic system is provided on a housing holding marking material. The universal electronic system stores first and second sets of configuration data for configuring the cartridge for operation with marking devices of first and second types. A second memory is provided and a control unit is included for selectively copying one of the first or second sets of configuration data from the first memory to the second memory for configuring the cartridge for operation with an associated printer based on identification information received from the printer. Several sets of configuration data are stored in the first memory for selective individual copying to the second memory for configuring the cartridge for use with printers of different types based upon identification information received from the printers.

### BACKGROUND

The present exemplary embodiments relate to universal replaceable consumable devices. They find particular application in conjunction with printing cartridges having on board electronic circuits, including ink and toner cartridges, and will be described with particular reference thereto. However, it is to be appreciated that the present exemplary embodiments are also amenable to other printing applications as well as in other applications such as where containers holding consumable substances or materials are used and anywhere containers are used to hold and selectively distribute consumable materials or other substances such as chemicals, biological indicators, medical fluids and the like.

In the printing arts, ink jet and laser printers are provided for placing various marks onto associated substrates such as paper sheets, labels, plastic sheets, cloth materials, edible confectionary products, etc. To that end, various original equipment manufacturers OEMs have provided highly specialized printers for these purposes. Typical printers require specific cartridge devices for use therewith holding the consumable marking material therein.

Consumers and end users have attempted to mix cartridge and printer types and styles to reuse old cartridges in new printers and for other reasons such as by mistake and to attempt to save costs. Obviously, ink jet printers will not operate if toner cartridges are installed. Conversely, laser printers cannot operate with ink. However, in practice within each of these broad categories of printing technologies, printing device OEMs have designed and developed printing apparatus which require highly specialized ink and toner cartridges for use by equally sophisticated printers. Typically, those cartridges are unique to particular printer models, styles, and types. Further, many modern cartridges have on board electronics holding parameters and other data needed by the printer to effectively use the cartridge for printing or to otherwise distribute materials from the cartridge. It is not uncommon for cartridge ink compatibility issues to arise even across the product line of a single original equipment manufacturer. Therefore, the market is faced with the need to provide many single replacement cartridges specific to each individual printing device.

There is a need, therefore, to provide universal cartridges for use with multiple printing apparatus. The universal cartridges would hold marking material or other materials or substances for use in printing apparatus of different types. In particular, there is a need for a universal smart chip provided on cartridges for adapting the cartridges for use with multiple printing apparatus.

### BRIEF DESCRIPTION

In accordance with one aspect of the present exemplary embodiments, a universal marking material cartridge is provided for use with an associated marking device selected from a plurality of different marking device types for making marks on an associated substrate. The universal marking material cartridge includes a housing holding a marking material therein, an outlet port formed in the housing for communicating the marking material from the housing to the associated marking device, and an electronic system on the housing. The electronic system includes a communication portion adapted to receive identification information from the associated marking device. Further, the electronic system includes a first memory storing first and second sets of configuration data, the first set of configuration data for configuring the cartridge for operation with a first associated marking device of a first type and a second set of configuration data for configuring the cartridge for operation with a second associated marking device of a second type different than the first type. A second memory is further provided in the electronic system together with a control unit adapted to selectively copy a one of the first set of configuration data and the second set of configuration data to the second memory as operating data for configuring the cartridge for operation with the associated marking device based on the identification information received from the communication portion.

In accordance with a further aspect of the present exemplary embodiments, a universal electronic system is provided for use with a marking material cartridge operative with an associated marking device selected from a plurality of marking device types for making marks on an associated substrate. The marking material cartridge includes a housing holding a marking material therein, and an outlet port formed in the housing for communicating the marking material from the housing to the associated marking device. The universal electronic system comprises a communication portion adapted to receive identification information from the associated marking device, a first memory storing first and second sets of configuration data, a second memory, and a control unit adapted to selectively copy, based on identification information received from the communication portion, a one of the first and second sets of configuration data through the first memory to the second memory for use as operating data for configuring the cartridge for operation with the associated marking device.

In accordance with a still further aspect of the present exemplary embodiments, a method in a universal marking material cartridge is provided for use with an associated marking device selected from a plurality of marking device types. The method comprises providing a housing holding a marking material therein, providing an outlet port formed in the housing for communicating the marking material from the housing to the associated marking device, providing an electronic system on the housing, and, using a control unit of the electronic system, copying a one of a first and second set of configuration data from a first memory portion of the electronic system to a second memory portion of the electronic system based on identification information received from the associated marking device for adapting the cartridge for use with the marking device.

Still further in accordance with yet another aspect of the present exemplary embodiments, a method in a marking material cartridge is provided for use with an associated marking device. The method includes providing an electronic system on a housing of the marking material cartridge, and copying a one of a first or second set of configuration data from a first memory portion of the electronic system to a second memory portion of the electronic system for use by the cartridge to adapt the cartridge for use with the associated marking device.

### BRIEF DESCRIPTION OF THE DRAWINGS

The invention may take form in certain components, structures, and steps, the preferred of which will be illustrated in the accompanying drawings.

FIG. 1 is a block diagram of a prior art printing system including a pair of printing devices and a pair of cartridges;

FIG. 2a is a schematic illustration of a marking material cartridge according to the prior art;

FIG. 2b is a table showing data stored in a memory device according to the prior art;

FIG. 3 is a schematic diagram of a universal marking material cartridge formed in accordance with a preferred embodiment of the application;

FIG. 4 is a schematic illustration of an electronic system carried on the cartridge of FIG. 3 and shown in schematic diagrammatic form; and,

FIG. 5 is a diagrammatical view illustrating contents of a memory device portion of the electronic system carried on the cartridge of FIG. 3.

### DETAILED DESCRIPTION OF THE PREFERRED EMBODIMENTS

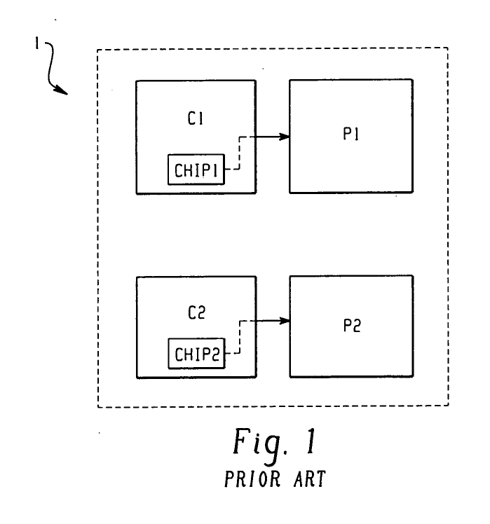

With reference to FIG. 1, a printing system 1 formed in accordance with the prior art is illustrated. As shown there, the printing system includes a first printing device P1 operable with a corresponding printing cartridge C1. Correspondingly, the system 1 includes a second printing device P2 operable with a corresponding printing cartridge C2. In the prior art system illustrated, electronic storage devices CHIP1, CHIP2 are applied to the cartridges C1, C2 and are interrogated during printer power-up sequences or the like using well-known techniques to retrieve a variety of data stored in the electronics contained on the cartridges into circuitry residing in the printing apparatus P1, P2.

In the prior art system illustrated, interlock data is used for preventing the first cartridge C1 from use with printers other than the first printing device P1 and, similarly, for preventing the use of the second cartridge C2 with printers other than the second printing device P2. Simply, the first cartridge C1 is compatible or operable only with the first printing device P1. Similarly, the second cartridge C2 is operable with the second printing device P2, exclusively.

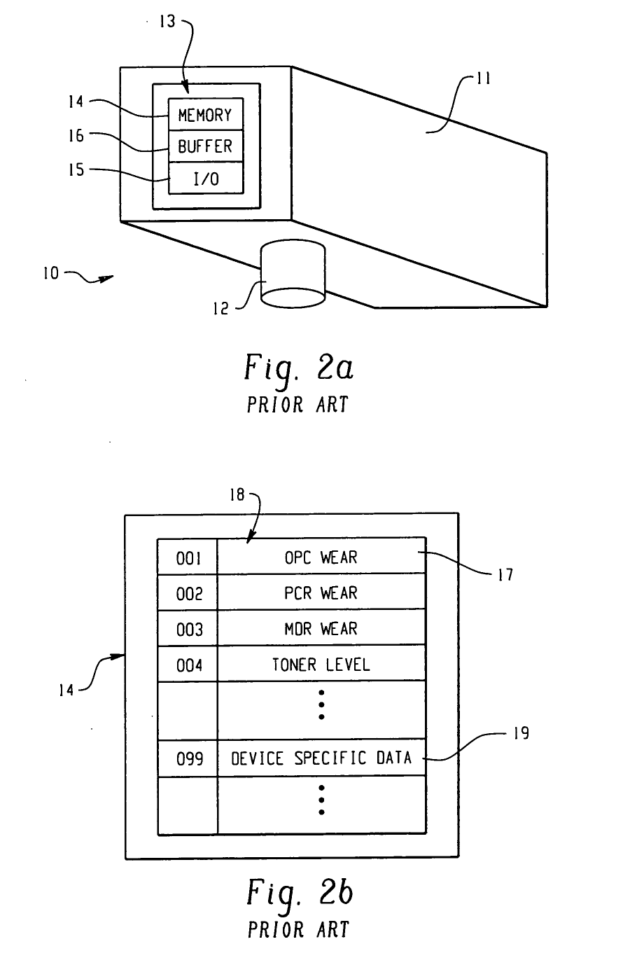

FIG. 2a is a schematic representation of a prior art marking material cartridge 10. Although an ink cartridge is illustrated, it is to be appreciated that the prior art description of the on board electronics is equally applicable to toner cartridges and cartridges containing other marking materials and substances. As shown, the prior art cartridge 10 includes a housing 11 holding a marking material (not shown) therein with an outlet port 12 formed in the housing for communication the marking material from the housing to an associated marking device. An electronic system 13 is provided on the housing for selective communication of parameters between the cartridge 10 and associated printing devices. Typical prior art electronic systems include a memory portion 14 for storing parameters relating primarily to the marking material contained within the cartridge and also relating to other data and information necessary for proper operation of the cartridge in the printer device. An input and output circuit 15 is provided for communicating the data stored in the memory 14 to the associated printing device. An intermediary buffer circuit 16 is located between the memory portion 14 and the input and output circuit 15.

FIG. 2b is a schematic illustration of the memory portion 14 of the prior art cartridge 10 of FIG. 2a showing a table 17 holding operating data 18 therein. For toner cartridges, typical operating data can include data indicative of the wear or condition of the optical photoconductor OPC in the printer, the wear or condition of the photoconductive roller PCR and of the magnetic drum roller MDR. Other useful information is toner level and the like. Importantly, however, the operating data 18 typically includes device specific data 19 which is useful only to printers adapted for use with the cartridge illustrated. As noted above, prior art marking material cartridges are not compatible with a wide range of printing devices indiscriminately. Rather, each printer is sensitive to the type of data contained within memory devices on the cartridges, the arrangement of the data stored in the memory devices, and the protocol used for accessing electronics on board the cartridges.

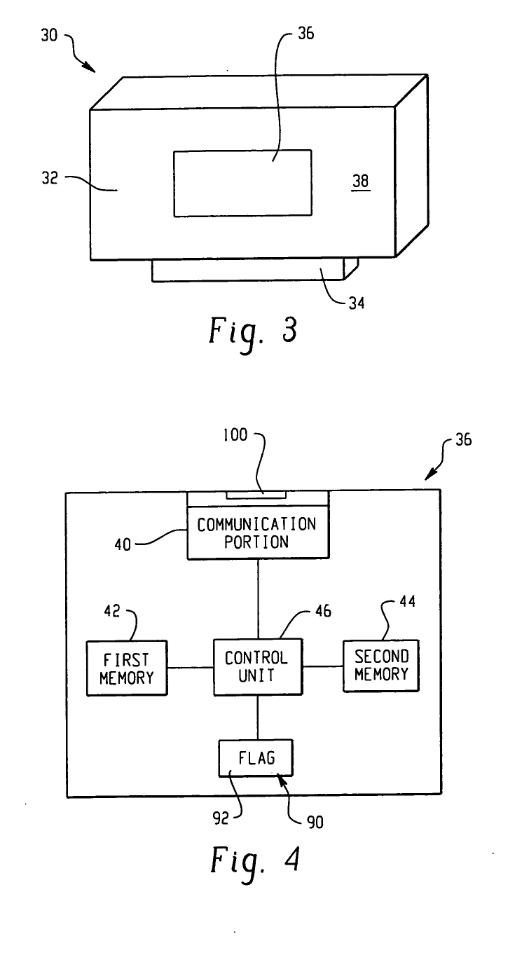

With reference now to FIG. 3, a universal marking cartridge 30 formed in accordance with a first preferred embodiment of the present application is illustrated in schematic form. As shown there, the cartridge 30 includes a housing 32 adapted to hold a marking material (not shown) therein. An outlet port 34 is formed on the housing 32 for communicating the marking material from the housing to an associated marking device. In the embodiment illustrated, the universal marking material cartridge 30 is in the form of a toner cartridge adapted to hold toner therein for use with an associated laser printing device. It is to be appreciated, however, that the invention is equally applicable to cartridges of any type for holding consumable materials therein and, in that regard, is not limited to toner cartridges. As an example, the preferred embodiments include ink cartridges, toner cartridges, consumable or edible material cartridges, cartridges holding industrial fluids and materials, biological material holders, and others.

With continued reference to FIG. 3, the universal marking material cartridge 30 includes an electronic system 36 disposed on an outer wall of the housing 32. In its preferred form, the electronic system 36 is carried on an outer wall 38 of the housing 32 and is oriented in a substantially vertical direction. In that way, when the cartridge is installed in the printer, the electronic system 36 is placed in close proximity to a corresponding electronic system (not shown) suitably positioned in the associated marking device. Operative communication can be affected by any known means including but not limited to a radio frequency link system, an electromechanical contact pad and contact pin system, infra-red transmitter and receiver pairs, and others.

FIG. 4 is a schematic representation of the electronic system 36 formed in accordance with a preferred embodiment. Turning now to that figure, the electronic system 36 includes a communication portion 40 adapted to communicate with a corresponding portion on the associated printer to exchange data and other information. The communication portion 40 receives identification information from the associated marking device. A first memory 42 is provided in the electronic system for storing a plurality of sets of configuration data including first and second sets of configuration data to be described in greater detail below. A second memory 44 is provided in the electronic system as well and, like the first memory 42 is in operative communication with a control unit 46 which, in its preferred form, is operatively coupled with the memory portions 42, 44 and the communication portion 40.

Preferably, the first memory 42 is a read only memory for holding data in a secure manner. The first memory 42 may be write protected regular memory. More particularly, the data stored in the first memory is read only data to maintain its integrity during operation of the subject cartridge 30 with the associated marking device. In contrast, for reasons which will become apparent below, the second memory 44 is rewritable for holding data which is changeable during operation of the subject cartridge 30 with the associated marking device.

In its preferred form, the first memory 42 is a one of a FLASH memory and a programmable read only memory (PROM) memory. The second memory 44, however, is preferably an electrically erasable programmable read only memory (EEPROM) memory.

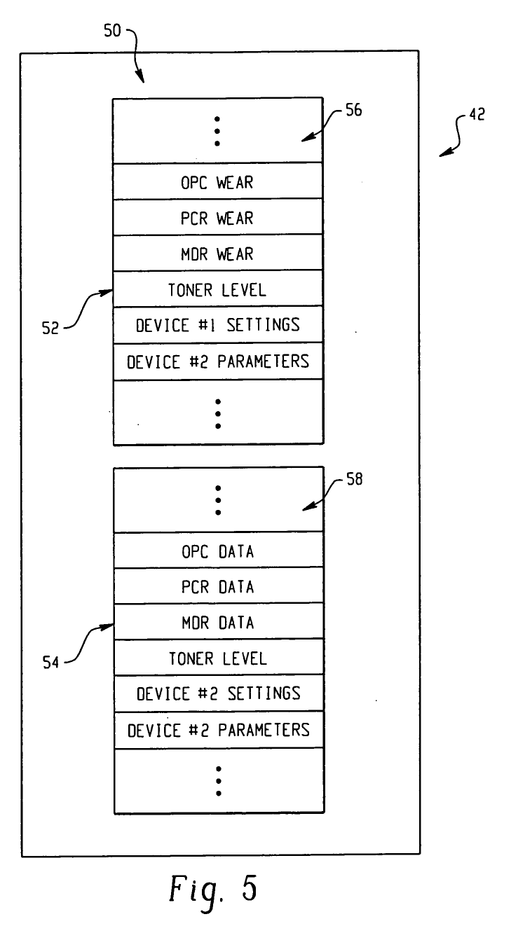

FIG. 5 shows a schematic illustration of the first memory 42 showing representative contents in accordance with a preferred embodiment. As shown there, the first memory 42 includes a plurality of memory locations 50 grouped into first and second sets of configuration data 52, 54, respectively. Only two configuration data sets are illustrated in the drawing figure for ease of explanation and clarity. However, it is to be appreciated that two or more sets of configuration data can be stored in the first memory 42 based on application or as deemed necessary or desired. In its preferred form, the first set of configuration data 52 includes information 56 adapted for configuring the cartridge 30 for operation with a marking device of a first type. Similarly, the second set of configuration data 54 includes information 58 for configuring the cartridge for operation with a marking device of a second type different from the first type.

More particularly, the information 56 contained in the first set of configuration data 52 includes, by way of example only, OPC, PCR, and MDR data appropriate or suitable for use with a first marking device of a first type. Further, device settings and device parameters are included in the information 56 associated with the first set 52 of configuration data. The second set 54 of configuration data includes information 58 relating to a second marking device of a second type different from the first type. To that end, OPC data, PCR data, and MDR data useful with the second marking device but not the first device is included together with the information 58 of the second set 54 of configuration data. Device setting data and parameter information useful to the second marking device of the second type are also contained together with the information 58 of the second set 54 of configuration data. It is to be appreciated that any form of data can be stored in the memory portions as desired. The data may relate to the date and time of manufacture, the date of last use, or any of a variety of useful data types.

With continued reference to FIG. 5 but with continued reference again to FIG. 4, the control unit 46 is adapted to selectively copy a one of the first set 52 of configuration data and a second set 54 of configuration data to the second memory 44 based on identification information received from the communication portion 40 during a power-up or system reset sequence of the subject cartridge 30. To that end, during power-up, the associated marking device interfaces with the subject cartridge 30 using a marking device interface portion 100 of the communication portion 40 to establish a suitable protocol therewith. The control unit 46 is adapted to interpret the communication protocol and store identification information 90 in a storage location 92 for providing a flag to determine a selected one of the first or second sets of configuration data 52, 54 to be copied from the first memory 42 to the second memory 44.

The marking device interface portion 100 operatively couples the electronic system 36 with the associated marking device for communicating, during operation of the associated marking device, the identification information 90 from the marking device to the control unit and selected portions of operating data stored in the second memory 44 to the associated marking device. In one embodiment, the marking device interface portion 100 includes a set of electromechanical contacts adapted to engage a corresponding set of communication contacts provided on the associated marking device. In another embodiment, the marking device interface portion 100 includes a radio frequency communication circuit adapted to communicate with a corresponding radio frequency communication portion disposed on the associated marking device. Other forms of electromechanical, electromagnetic, infra-red, or other device interfaces are also possible.

During operation of the associated marking device, the communication portion is adapted to receive update information from the associated marking device. The control unit 46 is adapted to replace selected portions of the operating data stored in the second memory 44 with the update information received from the communication portion. Examples of update information include OPC, PCR, and MDR where data changes, toner lever changes, usage time data, page counts, and the like. The present application is not limited to the above data types, however, and any data can be updated in the second memory 44 during operation of the subject cartridge 30 in the associated marking device.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A universal marking material cartridge for use with an associated marking device selected from a plurality of marking device types for making marks on an associated substrate, the universal marking material cartridge comprising:
a housing holding a marking material therein;
an outlet port formed in the housing for communicating the marking material from the housing to the associated marking device; and,
an electronic system on the housing, the electronic system including:
a communication portion adapted to receive identification information from the associated marking device;
a first memory storing first and second sets of configuration data, the first set of configuration data for configuring the cartridge for operation with a first associated marking device of a first type and the second set of configuration data for configuring the cartridge for operation with a second associated marking device of a second type different than said first type, the first and second types being among said plurality of marking device types;
a second memory; and,
a control unit adapted to selectively copy, based on said identification information received from said communication portion, a one of said first set of configuration data and said second set of configuration data to said second memory as operating data for configuring the cartridge for operation with said associated marking device.

2. The universal marking material cartridge according to claim 1 wherein:
said first memory is a one of a read only memory and a write protected memory; and,
said second memory is a rewritable memory.

3. The universal marking material cartridge according to claim 2 wherein said second memory is a non-volatile rewritable memory.

4. The universal marking material cartridge according to claim 2 wherein:
said first memory is a one of a FLASH memory and a PROM memory; and,
said second memory is an EEPROM memory.

5. The universal marking material cartridge according to claim 4 wherein said marking material is toner.

6. The universal marking material cartridge according to claim 4 wherein said marking material is ink.

7. The universal marking material cartridge according to claim 4 wherein:
said electronic system is a single electronic device including said communication portion, said first and second memories, and said control unit.

8. The universal marking material cartridge according to claim 7 wherein said electronic device is a large scale integrated circuit.

9. The universal marking material cartridge according to claim 8 wherein said electronic device is a microcontroller.

10. The universal marking material cartridge according to claim 2 wherein:
said communication portion includes a marking device interface operatively coupling said electronic system with said associated marking device for communicating, during operation of the associated marking device, said identification information from the associated marking device to the control unit and selected portions of said operating data from the second memory to the associated marking device.

11. The universal marking material cartridge according to claim 10 wherein:
said marking device interface is a one of a set of electromechanical contacts adapted to engage a corresponding set of communication contacts on the associated marking device, a radio frequency communication circuit adapted to communicate with a corresponding radio frequency communication portion on the associated marking device, and an infra-red communication circuit adapted to communicate with a corresponding infra-red communication portion on the associated marking device.

12. The universal marking material cartridge according to claim 10 wherein:
said communication portion is adapted to receive update information from the associated marking device during operation of the associated marking device; and,
said control unit is adapted to replace selected portions of said operating data stored in said second memory with the update information received by the communication portion.

13. The universal marking material cartridge according to claim 12 wherein:
said control unit is responsive to commands received by said communication portion from said associated marking device during operation of the associated marking device to access selected portions of said operating data and transfer the selected portions of the operating data to the associated marking device using the communication portion.

14. The universal marking material cartridge according to claim 12 wherein said update information received from the associated marking device includes at least one of usage information relating to usage of an optical photoconductor (OPC), a photoconductive roller (PCR) status information, magnetic drum roller (MDR) status information, and a level of usage/depletion of said marking material.

15. The universal marking material cartridge according to claim 1 wherein:
the control unit includes means for preventing overwriting of the operating data stored in the second memory after said one of said first set of configuration data and said second set of configuration data is copied to the second memory.

16. The universal marking material cartridge according to claim 15 wherein said means for preventing overwriting of the operating data stored in the second memory includes an initialization flag set after said one of said first set of configuration data and said second set of configuration data is copied to the second memory.

17. The universal marking material cartridge according to claim 16 wherein said initialization flag is stored in a non-volatile memory location of said electronic system.

18. The universal marking material cartridge according to claim 1 wherein said identification information received from the associated marking device by the communication portion is a one of a communication protocol, a series or sequence of signals, a voltage level, and identification data.

19. The universal marking material cartridge according to claim 1 wherein:
said first memory stores a plurality of sets of configuration data, each of the plurality of sets of configuration data for configuring the cartridge for operation with a first associated marking device of a plurality of types; and,
said control unit is adapted to selectively copy, based on said identification information received from said communication portion, a one of said plurality of sets of configuration data to said second memory as said operating data for configuring the cartridge for operation with said associated marking device.

20. A universal electronic system for use with a marking material cartridge operative with an associated marking device selected from a plurality of marking device types for making marks on an associated substrate, the marking material cartridge including a housing holding a marking material therein, and an outlet port formed in the housing for communicating the marking material from the housing to the associated marking device, the electronic system comprising:
a communication portion adapted to receive identification information from the associated marking device;
a first memory storing first and second sets of configuration data, the first set of configuration data for configuring the cartridge for operation with a first associated marking device of a first type and the second set of configuration data for configuring the cartridge for operation with a second associated marking device of a second type different than said first type, the first and second types being among said plurality of marking device types;
a second memory; and,
a control unit adapted to selectively copy, based on said identification information received from said communication portion, a one of said first set of configuration data and said second set of configuration data to said second memory as operating data for configuring the cartridge for operation with said associated marking device.

21. The universal electronic system according to claim 20 wherein:
said first memory is a one of a read only memory and a write protected memory; and,
said second memory is a rewritable memory.

22. The universal electronic system according to claim 21 wherein said second memory is a non-volatile rewritable memory.

23. The universal electronic system according to claim 21 wherein:
said first memory is a one of a FLASH memory and a PROM memory; and,
said second memory is an EEPROM memory.

24. The universal electronic system according to claim 20 wherein:
said electronic system is a single electronic device including said communication portion, said first and second memories, and said control unit.

25. The universal electronic system according to claim 24 wherein said electronic device is a large scale integrated circuit.

26. The universal electronic system according to claim 25 wherein said electronic device is a microcontroller.

27. The universal electronic system according to claim 20 wherein:
said communication portion includes a marking device interface operatively coupling said electronic system with said associated marking device for communicating, during operation of the associated marking device, said identification information from the associated marking device to the control unit and selected portions of said operating data from the second memory to the associated marking device.

28. The universal electronic system according to claim 27 wherein:
said marking device interface is a one of a set of electromechanical contacts adapted to engage a corresponding set of communication contacts on the associated marking device, a radio frequency communication circuit adapted to communicate with a corresponding radio frequency communication portion on the associated marking device, and an infra-red communication circuit adapted to communicate with a corresponding infra-red communication portion on the associated marking device.

29. The universal electronic system according to claim 27 wherein:
said communication portion is adapted to receive update information from the associated marking device during operation of the associated marking device; and,
said control unit is adapted to replace selected portions of said operating data stored in said second memory with the update information received by the communication portion.

30. The universal electronic system according to claim 20 wherein:
the control unit includes means for preventing overwriting of the operating data stored in the second memory after said one of said first set of configuration data and said second set of configuration data is copied to the second memory.

31. The universal electronic system according to claim 30 wherein said means for preventing overwriting of the operating data stored in the second memory includes an initialization flag set after said one of said first set of configuration data and said second set of configuration data is copied to the second memory.

32. A method in a universal marking material cartridge for use with an associated marking device selected from a plurality of marking device types for making marks on an associated substrate, the method comprising:
providing a housing holding a marking material therein;
providing an outlet port formed in the housing for communicating the marking material from the housing to the associated marking device;
providing an electronic system on the housing, the electronic system including:
a communication portion adapted to receive identification information from the associated marking device;
a first memory storing first and second sets of configuration data, the first set of configuration data for configuring the cartridge for operation with a first associated marking device of a first type and the second set of configuration data for configuring the cartridge for operation with a second associated marking device of a second type different than said first type, the first and second types being among said plurality of marking device types;
a second memory; and,
a control unit adapted to selectively copy, based on said identification information received from said communication portion, a one of said first set of configuration data and said second set of configuration data to said second memory as operating data for configuring the cartridge for operation with said associated marking device; and,
using said control unit, copying a one of said first set of configuration data and said second set of configuration data, based on said identification information received from the communication portion, to said second memory as said operating data.

33. A method in a marking material cartridge for use with an associated marking device selected from a plurality of marking device types for making marks on an associated substrate, the cartridge including a housing holding a marking material therein, and an outlet port formed in the housing for communicating the marking material from the housing to the associated marking device, the method comprising:
providing an electronic system on the housing, the electronic system including:
a communication portion adapted to receive identification information from the associated marking device;
a first memory storing first and second sets of configuration data, the first set of configuration data for configuring the cartridge for operation with a first associated marking device of a first type and the second set of configuration data for configuring the cartridge for operation with a second associated marking device of a second type different than said first type, the first and second types being among said plurality of marking device types;
a second memory; and,
a control unit adapted to selectively copy, based on said identification information received from said communication portion, a one of said first set of configuration data and said second set of configuration data to said second memory as operating data for configuring the cartridge for operation with said associated marking device; and,
using said control unit, copying a one of said first set of configuration data and said second set of configuration data, based on said identification information received from the communication portion, to said second memory as said operating data.
